(19) United States
(12) Patent Application Publication
(10) Pub. No.: US 2015/0214549 A1
(43) Pub. Date: Jul. 30, 2015

(54) ELECTRODE CELL AND BATTERY COMPRISING THE SAME

(71) Applicants: TOYOTA JIDOSHA KABUSHIKI KAISHA, Toyota-shi, Aichi (JP); KYOTO UNIVERSITY, Kyoto-shi, Kyoto (JP)

(72) Inventors: Koji Suto, Mishima-shi (JP); Katsunori Nakaya, Wako-shi (JP); Zempachi Ogumi, Kyoto-city (JP); Toshiro Hirai, Tokyo-to (JP); Akiyoshi Nakata, Kobe-city (JP)

(21) Appl. No.: 14/422,487

(22) PCT Filed: Jul. 29, 2013
(86) PCT No.: PCT/JP2013/070445

§ 371 Date: Feb. 19, 2015

(30) Foreign Application Priority Data
Aug. 21, 2012 (JP) 2012-182478

(51) Int. Cl. H01M 4/58; H01M 4/38; H01M 4/62; H01M 4/136; H01M 10/054; H01M 10/056

(52) U.S. Cl. CPC H01M 4/582; H01M 10/054; H01M 10/056; H01M 4/625; H01M 4/623; H01M 4/136; H01M 4/38; H01M 2004/028

(57) ABSTRACT

The present invention is to provide an electrode cell which is, when used in a battery, able to improve cycle characteristics of the battery, and a battery including the electrode cell. Presented is an electrode cell including at least an electrode active material layer and an electrolyte layer, wherein the electrode active material layer contains at least one electrode active material selected from the group of: vanadium(III) chloride, lead(II) chloride, tungsten(II) chloride, nickel(II) chloride, vanadium, lead, tungsten and nickel, and wherein the electrolyte layer contains an electrolyte containing aluminum(III) chloride and an ionic liquid that contains a chloride ion and organic onium cation.

### TECHNICAL FIELD

The present invention relates to an electrode cell which is, when used in a battery, able to improve cycle characteristics of the battery, and a battery comprising the electrode cell.

### BACKGROUND ART

A secondary battery is a battery that is able to convert chemical energy into electrical energy and discharge the energy. Moreover, it is also a battery that is able to convert electrical energy into chemical energy and store (charge) the chemical energy, by passing electrical current in a direction that is opposite to the one at the time of discharge.

Recently, there has been an increase in research and development of aluminum batteries (aluminum secondary batteries) in which aluminum metal is used in the anode. An aluminum battery is able to develop, due to high ionization tendency of aluminum metal, higher electromotive force than conventional batteries that use zinc metal in the anode (e.g., manganese batteries), and it is expected to provide high voltage and high capacity.

An aluminum battery is disclosed in Non-Patent Literature 1, in which iron(III) chloride is used in the cathode active material. According to the non-patent literature, in the cathode of the aluminum battery, upon discharging, the reaction described by the following formula (A-I) proceeds:

FeCl₃+Al₂Cl₇⁻+e⁻→FeCl₂+2AlCl₄⁻ Formula (A-I):

In the anode of the aluminum battery, upon discharging, the reaction described by the following formula (A-II) proceeds:

Al+3AlCl₄⁻+2FeCl₃→2Al₂Cl₇⁻+2FeCl₂+e⁻ Formula (A-II):

From the above formulae (A-I) and (A-II), the whole reaction formula that proceeds in the aluminum battery upon discharging is described by the following formula (A-III):

Al+AlCl₄⁻+3FeCl₃→Al₂Cl₇⁻+3FeCl₂ Formula (A-III):

A battery is also disclosed in Non-Patent Literature 1, in which a slurry of iron(III) chloride is used in the cathode; aluminum metal in cylindrical form is used in the anode; and 1-methyl-3-ethylimidazolium chloride and aluminum(III) chloride are used as electrolyte between the cathode and anode (see “2. Experimental details” in Non-Patent Literature 1).

### CITATION LIST

Non-Patent Literature 1: F. M. Donahue et al., Journal of Applied Electrochemistry 22 (1992) 230-234

### SUMMARY OF INVENTION

### Technical Problem

However, as shown in the below-described Comparative Example 1, in an aluminum battery in which iron(III) chloride is used as cathode active material, the iron(III) chloride is transferred into the electrolyte; therefore, the aluminum battery provides very poor cycle characteristics.

The present invention was achieved in light of the above circumstance. An object of the present invention is to provide an electrode cell which is, when used in a battery, able to improve cycle characteristics of the battery, and a battery comprising the electrode cell.

### Solution to Problem

The electrode cell of the present invention is an electrode cell comprising at least an electrode active material layer and an electrolyte layer, wherein the electrode active material layer contains at least one electrode active material selected from the group consisting of: vanadium(III) chloride, lead(II) chloride, tungsten(II) chloride, nickel(II) chloride, vanadium, lead, tungsten and nickel, and wherein the electrolyte layer contains an electrolyte containing aluminum(III) chloride and an ionic liquid that contains a chloride ion and organic onium cation.

In the present invention, the mole content ratio between the ionic liquid and aluminum(III) chloride in the electrolyte is preferably ionic liquid:aluminum(III) chloride=1.0 mol:1.5 mol to 1.0 mol:1.9 mol.

In the present invention, the organic onium cation can be at least one cation selected from the group consisting of quaternary ammonium cation, quaternary phosphonium cation, alkylimidazolium cation, guanidium cation, sulfonium cation, alkylpiperidinium cation and dialkylpyridinium cation.

In the present invention, the ionic liquid is preferably at least one ionic liquid selected from the group consisting of 1-ethyl-3-methylimidazolium chloride, N-methyl-N-propylpiperidinium chloride, and 1-butylpyridinium chloride.

In the present invention, the electrode active material layer can further contain at least one electroconductive material selected from the group consisting of mesoporous carbon, graphite, acetylene black, carbon black, carbon nanotubes and carbon fibers.

In the present invention, the electrode active material layer can further contain at least one binder selected from the group consisting of a fluoride polymer and styrene-butadiene rubber.

The battery of the present invention is a battery comprising an anode active material layer and the electrode cell, wherein the anode active material layer and the cathode active material layer of the electrode cell are disposed so that the electrolyte layer of the electrode cell is present therebetween, and wherein the anode active material layer is a simple substance or compound that contains at least one element selected from the group consisting of carbon, platinum, palladium, rhodium, ruthenium, gold, tungsten, aluminum, lithium, magnesium, calcium, iron, nickel, copper, manganese, chromium, zinc, silicon and titanium.

In the present invention, the anode active material layer preferably contains aluminum metal, an aluminum alloy or an aluminum compound as anode active material.

### Advantageous Effects of Invention

According to the present invention, a metal chloride which is less soluble in electrolyte is used as electrode active material; therefore, a battery comprising such an electrode cell is able to charge and discharge reversibly, and it provides better cycle characteristics than conventional aluminum batteries in which iron(III) chloride is used as cathode active material.

### BRIEF DESCRIPTION OF DRAWINGS

FIG. 1 is a view showing a first typical example of the laminate structure of the electrode cell according to the present invention, and it is also a schematic sectional view along the laminating direction.

FIG. 2 is a view showing a second typical example of the laminate structure of the electrode cell according to the present invention, and it is also a schematic sectional view along the laminating direction.

FIG. 3 is a view showing a first typical example of the laminate structure of the battery according to the present invention, and it is also a schematic sectional view along the laminating direction.

FIG. 4 is a view showing a second typical example of the laminate structure of the battery according to the present invention, and it is also a schematic sectional view along the laminating direction.

FIG. 5 shows a cyclic voltammogram of the battery of Example 1.

FIG. 6 shows a cyclic voltammogram of the battery of Example 2.

FIG. 7 shows a cyclic voltammogram of the battery of Example 3.

FIG. 8 shows a cyclic voltammogram of the battery of Example 4.

FIG. 9 shows a cyclic chronopotentiogram of the battery of Example 1.

FIG. 10 is a bar chart comparing the reduction capacity retention at each cycle of the battery of Example 1 to that of the battery of Comparative Example 1.

FIG. 11 is a chart showing a cyclic chronopotentiogram of the battery of Comparative Example 1, being overlapped with a transition of capacity with respect to time.

FIG. 12 is a chart showing a cyclic chronopotentiogram of the battery of Comparative Example 1.

### DESCRIPTION OF EMBODIMENTS

### 1. Electrode Cell

The electrode cell of the present invention is an electrode cell comprising at least an electrode active material layer and an electrolyte layer, wherein the electrode active material layer contains at least one electrode active material selected from the group consisting of: vanadium(III) chloride, lead(II) chloride, tungsten(II) chloride, nickel(II) chloride, vanadium, lead, tungsten and nickel, and wherein the electrolyte layer contains an electrolyte containing aluminum(III) chloride and an ionic liquid that contains a chloride ion and organic onium cation.

In general, to realize electrochemical devices that are capable of repeated charging and discharging, it is required that electrochemical devices are capable of oxidation reduction, which is an electrochemically reversible reaction. However, as described above, in conventional aluminum batteries as mentioned in Non-Patent Literature 1, oxidation reduction proceeds irreversibly and results in poor cycle characteristics. Therefore, it is considered to be difficult to use conventional aluminum batteries as mentioned in Non-Patent Literature 1, as electrochemical devices capable of repeated charging and discharging.

To study the aluminum batteries described in Non-Patent Literature 1, an aluminum battery was reproduced and used for cyclic chronopotentiometry (Comparative Example 1) under the below-described “Examples”, the battery comprising iron(III) chloride as cathode active material and aluminum metal as anode. As is clear from the result of the cyclic chronopotentiometry, on the battery of Comparative Example 1, electrochemical reduction (initial reduction) and oxidation (initial oxidation) were carried out in a given current value condition, followed by another electrochemical reduction (second reduction); however, almost no reduction current flowed. That is, it is clear that the battery of Comparative Example 1 is an electrochemically-irreversible battery that is capable of only the initial reduction.

The reason why the conventional aluminum battery as disclosed in Non-Patent Literature 1 is electrochemically irreversible is as follows.

As is shown by the solubility test of the electrode active materials in electrolytes, which will be described below under “Examples”, it has been proved that the saturated solubility concentration of iron(III) chloride in an electrolyte containing an ionic liquid and aluminum(III) chloride (the mole content ratio between 1-ethyl-3-methylimidazolium chloride and aluminum(III) chloride is as follows: 1-ethyl-3-methylimidazolium chloride:aluminum(III) chloride=1.0:1.5) is more than 0.1 mol/L and this is significantly high.

The reason why an oxidation-reduction reaction shown in an electrochemical device is irreversible when, as just described, the solubility of the electrode active material in the electrolyte is significantly high, is as follows.

The electrode active material dissolved from the electrode into the electrolyte and migrating in the electrolyte, is reduced on the surface of the opposite electrode and causes self discharge. This self discharge is notably caused when the self diffusion of ions derived from the electrode active material is as high as the level of the same found in general electrochemical devices, and the reduction potential of the electrode active material is higher than the equilibrium potential of the opposite electrode.

In the case of using a highly viscous electrolyte, the migration rate of ions derived from the electrode active material becomes slow; therefore, a significant decrease in charge/discharge rate is caused in an electrochemical device. As a result, especially in the case of constant potential oxidation, a rapid increase in overvoltage occurs and an electrolyte decomposition reaction is secondarily caused at higher potential; therefore, the electrochemical device is irreversibly deteriorated.

As a result of diligent research on the above problem, the inventors of the present invention have found that it is difficult to design an electrochemical device that is able to cause electrochemically-reversible oxidation-reduction reactions, unless the dissolution of the electrode active material into the electrolyte is prevented. For an electrode cell containing, as electrode active material, a metal chloride which has significantly low solubility in electrolyte, the inventors of the present invention have found that a battery comprising the electrode cell is able to cause electrochemically-reversible oxidation-reduction reactions and provides excellent cycle characteristics, therefore. Based on this finding, the inventors achieved the present invention.

The electrode cell of the present invention comprises at least an electrode active material layer and an electrolyte layer. In addition to the electrode active material layer and the electrolyte layer, the electrode cell of the present invention can generally comprise an electrode current collector and an electrode lead connected to the electrode current collector.

Hereinafter, the electrode active material layer and electrolyte layer used in the present invention, the electrode current collector which can be used in the present invention, and a method for producing the electrode cell of the present invention, will be described in order.

The electrode active material layer used in the present invention contains, as electrode active material, vanadium(III) chloride (VCl₃), lead(II) chloride (PbCl₂), tungsten(II) chloride (WCl₂) or nickel(II) chloride (NiCl₂), or the electrode active material layer contains vanadium (V), lead (Pb), tungsten (W) or nickel (Ni), which are reductants of these metal chlorides. When the electrode cell of the present invention is used in a battery and the battery is in a charged state, the electrode active material is vanadium(III) chloride, lead(II) chloride, tungsten(II) chloride or nickel(II) chloride. These electrode active materials can be used alone or in combination of two or more kinds.

First, electrochemical reactions shown in a battery containing vanadium(III) chloride as cathode active material will be discussed. In the following discussion, the battery is one comprising aluminum metal as anode and further containing aluminum(III) chloride in the electrolyte.

In the cathode containing vanadium(III) chloride, upon discharging, two-step reactions described by the following half reaction formulae (B-Ia) and (B-Ib) proceed. In each formula, what is shown in parentheses is the equilibrium potential of each reaction, which is presumed from the experimental results of the below-described battery of Example 1.

VCl₃+Al₂Cl₇⁻+e⁻→VCl₂+2AlCl₄⁻ (1.1V vs. Al³⁺/Al) Formula (B-Ia):

VCl₂+2Al₂Cl₇⁻+2e⁻→V+4AlCl₄⁻ (0.6V vs. Al³⁺/Al) Formula (B-Ib):

In the anode of the battery, upon discharging, the reaction described by the following half reaction formula (B-II) proceeds.

Al+7AlCl₄⁻→4Al₂Cl₇+3e⁻ Formula (B-II):

From the above formulae (B-Ia), (B-Ib) and (B-II), the reaction which proceeds in the battery as the battery state changes from a fully charged state to a discharged state, can be described by the following whole reaction formula (B-III). As an example of a counter cation relative to the anion shown in the whole reaction formula (B-III), there may be mentioned an organic onium cation that will be described below.

Al+AlCl₄⁻+VCl₃→Al₂Cl₇⁻+V Formula (B-III):

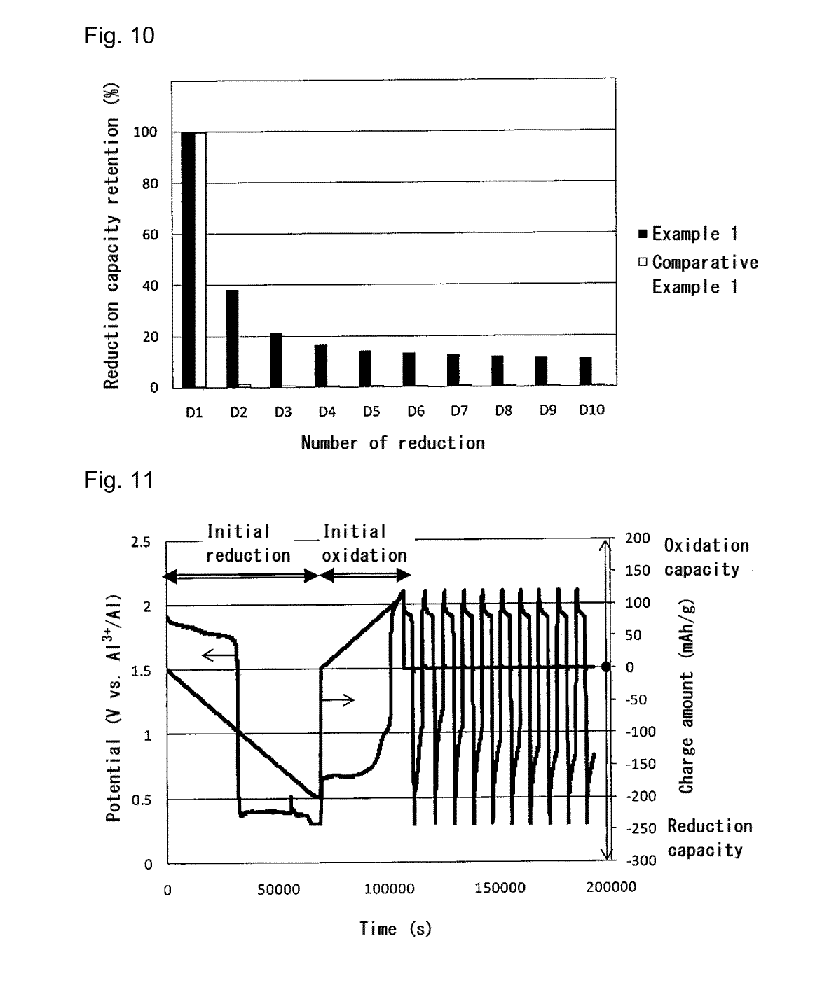

The reaction which is reverse to the above whole reaction formula (B-III), that is, the reaction which proceeds in the battery as the battery state changes from a discharged state to a fully charged state, is considered to be somewhat slow. As shown in the below-mentioned FIG. 9, in the reverse reaction, the constant potential region (plateau region) especially near 0.6 V significantly decreases cycle by cycle.

In the case of a battery using an electrode cell in which vanadium metal is contained as cathode active material, contrary to the battery using the electrode cell in which vanadium(III) chloride is used as cathode active material, the beginning of the whole reaction starts off with a charging reaction (reaction reverse to the formula (B-III)).

From the below-described result of cyclic voltammetry on the battery of Example 1, it is clear that the vanadium species contained in the battery of Example 1 is reversibly oxidized and reduced between the 0 valence state and the +3 valence state. From the result of cyclic chronopotentiometry on the battery of Example 1, it is clear that at least 10 cycles of reversibly-stable oxidation-reduction occurs in the battery.

In addition, from the below-described result of the solubility test of vanadium(III) chloride in the electrolyte, it is clear that the saturated solubility concentration of vanadium(III) chloride in the electrolyte is as very low as 1.98 mmol/L. Accordingly, it has been proved that vanadium(III) chloride is almost insoluble in the electrolyte which is generally used in batteries.

Next, electrochemical reactions shown in a battery containing lead(II) chloride as cathode active material will be discussed. In the following discussion, the battery is one comprising aluminum metal as anode and further containing aluminum(III) chloride in the electrolyte.

In the cathode of the battery, upon discharging, the reaction described by the following half reaction formula (C-I) proceeds.

PbCl₂+2Al₂Cl₇⁻+2e⁻→Pb+4AlCl₄⁻ Formula (C-I):

In the anode of the battery, upon discharging, the reaction described by the following half reaction formula (C-II) proceeds.

Al+7AlCl₄⁻→4Al₂Cl₇⁻+3e⁻ Formula (C-II):

From the above formulae (C-I) and (C-II), the reaction which proceeds in the battery as the battery state changes from a fully charged state to a discharged state, can be described by the following whole reaction formula (C-III). As an example of a counter cation relative to the anion shown in the whole reaction formula (C-III), there may be mentioned an organic onium cation that will be described below.

2Al+2AlCl₄⁻+3PbCl₂→2Al₂Cl₇⁻+3Pb Formula (C-III):

In the case of a battery using an electrode cell in which lead metal is contained as cathode active material, contrary to the battery using the electrode cell in which lead(II) chloride is contained as cathode active material, the beginning of the whole reaction starts off with a charging reaction (reaction reverse to the formula (C-III)).

From the below-described result of cyclic voltammetry on the battery of Example 2, it is clear that the lead species contained in the battery of Example 2 is reversibly oxidized and reduced between the 0 valence state and the +2 valence state. From the cyclic voltammetry result, therefore, it is presumed that reversibly-stable oxidation-reduction is caused in the battery and the battery shows excellent cycle characteristics.

Next, electrochemical reactions shown in a battery containing tungsten(II) chloride as cathode active material will be discussed. In the following discussion, the battery is one comprising aluminum metal as anode and further containing aluminum(III) chloride in the electrolyte.

In the cathode of the battery, upon discharging, the reaction described by the following half reaction formula (D-I) proceeds.

WCl₂+2Al₂Cl₇⁻+2e⁻→W+4AlCl₄⁻ Formula (D-I):

In the anode of the battery, upon discharging, the reaction described by the following half reaction formula (D-II) proceeds.

Al+7AlCl₄⁻→4Al₂Cl₇⁻+3e⁻ Formula (D-II):

From the above formulae (D-I) and (D-II), the reaction which proceeds in the battery as the battery state changes from a fully charged state to a discharged state, can be described by the following whole reaction formula (D-III). As an example of a counter cation relative to the anion shown in the whole reaction formula (D-III), there may be mentioned an organic onium cation that will be described below.

2Al+2AlCl₄⁻+3WCl₂→2Al₂Cl₇⁻+3W Formula (D-III):

In the case of a battery using an electrode cell in which tungsten metal is contained as cathode active material, contrary to the battery using the electrode cell in which tungsten(II) chloride is contained as cathode active material, the beginning of the whole reaction starts off with a charging reaction (reaction reverse to the formula (D-III)).

From the below-described result of cyclic voltammetry on the battery of Example 3, it is clear that the tungsten species contained in the battery of Example 3 is reversibly oxidized and reduced between the 0 valence state and the +2 valence state. From the cyclic voltammetry result, therefore, it is presumed that reversibly-stable oxidation-reduction is caused in the battery and the battery shows excellent cycle characteristics.

Finally, electrochemical reactions shown in the battery containing nickel(II) chloride as cathode active material will be discussed. In the following discussion, the battery is one comprising an aluminum metal as anode and further containing aluminum(III) chloride in the electrolyte.

In the cathode of the battery, upon discharging, the reaction described by the following half reaction formula (E-I) proceeds.

NiCl₂+2Al₂Cl₇⁻+2e⁻→Ni+4AlCl₄⁻ Formula (E-I):

In the anode of the battery, upon discharging, the reaction described by the following half reaction formula (E-II) proceeds.

Al+7AlCl₄⁻→4Al₂Cl₇⁻+3e⁻ Formula (E-II):

From the above formulae (E-I) and (E-II), the reaction which proceeds in the battery as the battery state changes from a fully charged state to a discharged state, can be described by the following whole reaction formula (E-III). As an example of a counter cation relative to the anion shown in the whole reaction formula (E-III), there may be mentioned an organic onium cation that will be described below.

2Al+2AlCl₄⁻+3NiCl₂→2Al₂Cl₇⁻+3Ni Formula (E-III):

In the case of a battery using an electrode cell in which nickel metal is contained as cathode active material, contrary to the battery using the electrode cell in which nickel(II) chloride is contained as cathode active material, the beginning of the whole reaction starts off with a charging reaction (reaction reverse to the formula (E-III)).

From the below-described result of cyclic voltammetry on the battery of Example 4, it is clear that the nickel species contained in the battery of Example 4 is reversibly oxidized and reduced between the 0 valence state and the +2 valence state. From the cyclic voltammetry result, therefore, it is presumed that reversibly-stable oxidation-reduction is caused in the battery and the battery shows excellent cycle characteristics.

In addition to the above-mentioned electrode active material, the electrode active material layer used in the present invention can contain at least one of an electroconductive material and a binder.

The electroconductive material used in the present invention is not particularly limited, as long as it is electroconductive and it does not interfere with the above-mentioned electrode reactions. Examples of the electroconductive material used in the present invention include carbonaceous materials, perovskite-type electroconductive materials, porous electroconductive polymers and porous metal materials. Carbonaceous materials can be porous or non-porous carbonaceous materials. Concrete examples of porous carbonaceous materials include mesoporous carbons. Concrete examples of non-porous carbonaceous materials include graphite, acetylene black, carbon nanotubes and carbon fibers.

The content ratio of the electroconductive material in the electrode active material layer is not particularly limited. For example, it is preferably 50% by mass or less, particularly preferably 1% by mass to 40% by mass.

The binder used in the present invention is not particularly limited, as long as it increases binding force in the electrode active material layer and it does not interfere with the above-mentioned electrode reactions. Examples of the binder used in the present invention include fluoride polymers such as polyvinylidene fluoride (PVDF) and polytetrafluoroethylene (PTFE) and rubber-based resins such as styrene-butadiene rubber (SBR rubber).

The content ratio of the binder in the electrode active material layer is not particularly limited. For example, it is 30% by mass or less. Preferably, it is 1% by mass to 20% by mass.

The thickness of the electrode active material layer used in the present invention varies, for example, depending on the use of the battery. For example, it is preferably 1 to 500 μm.

The electrolyte layer used in the present invention contains an electrolyte that contains an ionic liquid and aluminum(III) chloride.

The ionic liquid used in the present invention contains a chloride ion and organic onium cation. As used herein, “organic onium cation” is an organic cation in which a neutral heteroatom is contained in the structure, and it is also a positively-charged organic cation which is positively charged by coordinating a positively-charged monovalent alkyl group (carbocation) with the heteroatom and thus increasing the valence by one.

The organic onium cation used in the present invention is not particularly limited, as long as it does not interfere with the above-mentioned electrode reactions. Examples of the organic onium cation used in the present invention include quaternary ammonium cation, quaternary phosphonium cation, alkylimidazolium cation, guanidium cation, sulfonium cation, alkylpiperidinium cation and dialkylpyridinium cation. These organic onium cations can be used alone or in combination of two or more kinds. Also, there may be used derivatives of these cations, such as hydroxyl group- or allyl group-substituted cations (which are these cations). The above-mentioned electrochemical reactions used in the present invention, (B-III), (C-III), (D-III) and (E-III), have a small difference in performance, which is attributed to the difference in cation species contained in their electrolytes. In the present invention, the difference in cation species contained in their electrolytes contributes to, at best, the difference in equilibrium potentials between the electrochemical reactions, which are attributed to the difference in solvation energy, etc.

Concrete examples of the ionic liquid used in the present invention include 1-ethyl-3-methylimidazolium chloride, N-methyl-N-propylpiperidinium chloride, 1-butylpyridinium chloride, N-butyl-N-methylpiperidinium chloride, 1-ethyl-2,3-dimethylimidazolium chloride, 1-octadecyl-3-imidazolium chloride, 1-butyl-1-methylpyrrolidinium chloride, 1,1-dimethyl-1-ethyl-methoxyethyl ammonium chloride, and trihexyltetradecyl phosphonium chloride. Of these ionic liquids, 1-ethyl-3-methylimidazolium chloride, N-methyl-N-propylpiperidinium chloride or 1-butylpyridinium chloride is preferably used. These ionic liquids can be used alone or in combination of two or more kinds.

The mole content ratio between the ionic liquid and aluminum(III) chloride in the electrolyte is preferably as follows: ionic liquid:aluminum(III) chloride=1.0 mol:1.5 mol to 1.0 mol:1.9 mol.

In the present invention, depending on the content ratio between the ionic liquid and aluminum(III) chloride in the electrolyte, the anion species in the electrolyte also vary. For example, when the mole content of the aluminum(III) chloride in the electrolyte is smaller than the mole content of the ionic liquid in the electrolyte, the majority of anions in the electrolyte are chloride anions (Cl⁻). When the mole content ratio between the ionic liquid and aluminum(III) chloride in the electrolyte is ionic liquid:aluminum(III) chloride=1.0 mol:1.0 mol to 1.0 mol:1.4 mol, the majority of anions in the electrolyte are those described by AlCl₄⁻. When the mole content ratio between the ionic liquid and aluminum(III) chloride in the electrolyte is ionic liquid:aluminum(III) chloride=1.0 mol:1.5 mol to 1.0 mol:1.9 mol, the majority of anions in the electrolyte are those described by Al₂Cl₇⁻. When the mole content ratio between the ionic liquid and aluminum(III) chloride in the electrolyte is ionic liquid:aluminum(III) chloride=1.0 mol:1.95 mol to 1.0 mol:2.0 mol, Al₃Cl₁₀⁻ appears in the electrolyte. As the number of aluminum nuclei in the anions increases, Lewis acidity increases; therefore, bases such as chloride ions are attracted more strongly. As the mole content ratio between the ionic liquid and aluminum(III) chloride in the electrolyte varies, the solubility of the electrode active material in the electrolyte, the reactivity of the electrode active material with the electrolyte, and, when the electrode cell of the present invention is used in a battery, the presence of precipitation of the aluminum metal in the opposite electrode and the potential of the same also vary. Therefore, among the compositions of the electrolytes in which chloride anions (Cl⁻) are the majority; in which those described by AlCl₄⁻ are the majority; in which those described by Al₂Cl₇⁻ are the majority; and in which Al₃Cl₁₀⁻ appears, chemical equilibrium in electrolyte, electrode reactions, and electrochemical reactivity at the interface between electrode and electrolyte, vary.

In the above-mentioned mole content ratio range of ionic liquid:aluminum chloride=1.0 mol:1.5 mol to 1.0 mol:1.9 mol, the majority of anions in the electrolyte are those described by Al₂Cl₇⁻. In the mole content ratio range, the solubility of the above-mentioned electrode active material in the electrolyte is relatively low, and electrochemical oxidation-reduction is likely to occur.

The solubility of the above-mentioned electrode active materials (vanadium(III) chloride, lead(II) chloride, tungsten(II) chloride and nickel(II) chloride) in the electrolyte used in the present invention, is preferably as low as possible. When the solubility is too high, the electrode active material is dissolved into the electrolyte. As a result, there is a possibility that the above-mentioned self discharge is caused to deteriorate the battery and make the battery electrochemically irreversible.

Depending on the type of the electrode active material and the electrolyte, the solubility of the above-mentioned electrode active material in the electrolyte is preferably 0 to 5 mmol/L, more preferably 0 to 3 mmol/L.

The electrolyte used in the present invention can contain an organic solvent such as an ether-based solvent, a carbonate-based solvent or acetonitrile. Examples of the ether-based solvent include dimethyl ether, diethyl ether, ethyl methyl ether, tetrahydrofuran (THF) and 2-methyltetrahydrofuran. Examples of the carbonate-based solvent include ethylene carbonate (EC), propylene carbonate (PC), dimethyl carbonate (DMC), diethyl carbonate (DEC), ethyl methyl carbonate (EMC) and butylene carbonate.

The electrode cell of the present invention can further contain an electrode current collector.

The material for the electrode current collector is not particularly limited, as long as it is electroconductive. For examples, there may be mentioned platinum, stainless-steel, nickel, aluminum, iron, titanium and carbon. Examples of the form of an air electrode current collector include a foil form, a plate form and a mesh (grid) form. From the viewpoint of excellent current collection efficiency, the electrode current collector is preferably in a mesh form. In the present invention, the below-described battery case can also function as the electrode current collector.

The thickness of the electrode current collector is preferably 1 to 500 μm, for example.

Hereinafter, a typical example of the method for producing the electrode cell of the present invention will be described in detail.

First, the electrode active material layer is produced by, as needed, molding the electrode active material. The electrode active material layer can be also formed by mixing the electrode active material with the electroconductive material and/or the binder at an appropriate content ratio. In the case of using the electrode current collector, it can be laminated on one surface of the electrode active material layer.

As the electrolyte, a mixture obtained by mixing the above-mentioned ionic liquid and aluminum(III) chloride at a molar ratio of ionic liquid:aluminum(III) chloride=1.0:1.5 to 1.0:1.9, is used. Examples of the method for forming the electrolyte layer include a method of applying thinly and uniformly the electrolyte onto one surface of the molded electrode active material layer, using a spatula, etc., and a method of spraying the electrolyte to the electrode active material layer.

The above production process is preferably carried out in a low oxygen condition at an oxygen concentration of 0.5 ppm or less and a low moisture condition at a dew-point temperature of −85° C. or less.

The below-described battery can be produced by laminating the anode at the electrolyte side of the electrode cell.

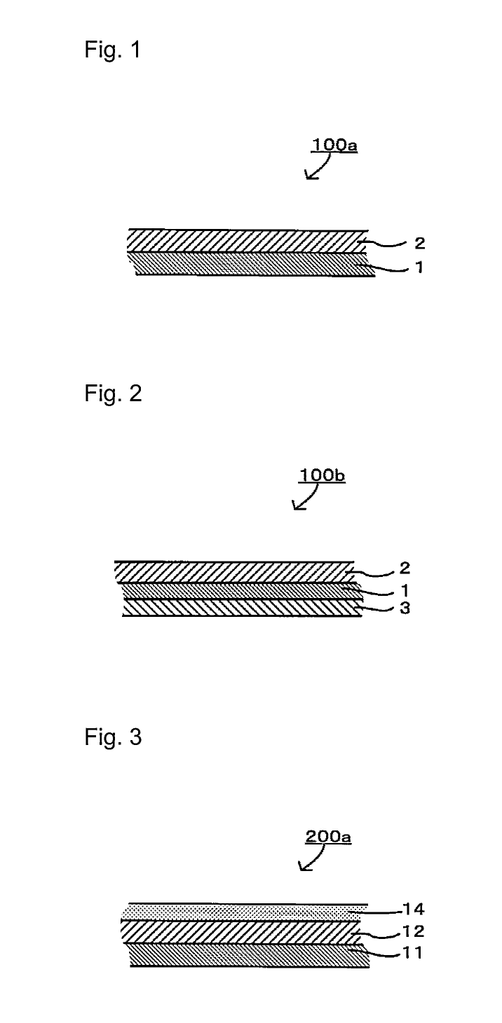

FIG. 1 is a view showing a first typical example of the laminate structure of the electrode cell according to the present invention, and it is also a schematic sectional view along the laminating direction. An electrode cell 100a comprises an electrode active material layer 1 and an electrolyte layer 2.

FIG. 2 is a view showing a second typical example of the laminate structure of the electrode cell according to the present invention, and it is also a schematic sectional view along the laminating direction. An electrode cell 100b is formed by laminating an electrode current collector 3, an electrode active material layer 1 and an electrolyte layer 2 in this order.

The electrode cell of the present invention is not limited to the first and second typical examples. The thicknesses of the layers shown in FIGS. 1 and 2 do not always reflect the thicknesses of the layers in the electrode cell of the present invention.

### 2. Battery

The battery of the present invention is a battery comprising an anode active material layer and the electrode cell, wherein the anode active material layer and the cathode active material layer of the electrode cell are disposed so that the electrolyte layer of the electrode cell is present therebetween, and wherein the anode active material layer is a simple substance or compound that contains at least one element selected from the group consisting of carbon, platinum, palladium, rhodium, ruthenium, gold, tungsten, aluminum, lithium, magnesium, calcium, iron, nickel, copper, manganese, chromium, zinc, silicon and titanium.

In the battery of the present invention, the electrode active material layer of the electrode cell is used as the cathode active material layer.

FIG. 3 is a view showing a first typical example of the laminate structure of the battery according to the present invention, and it is also a schematic sectional view along the laminating direction.

A battery 200a comprises a cathode active material layer 11, an anode active material layer 14, and an electrolyte layer 12 disposed between the cathode active material layer 11 and the anode active material layer 14. The cathode active material layer 11 and the electrolyte layer 12 correspond to the electrode active material layer 1 and the electrolyte layer 2 of the above-mentioned electrode cell 100a, respectively.

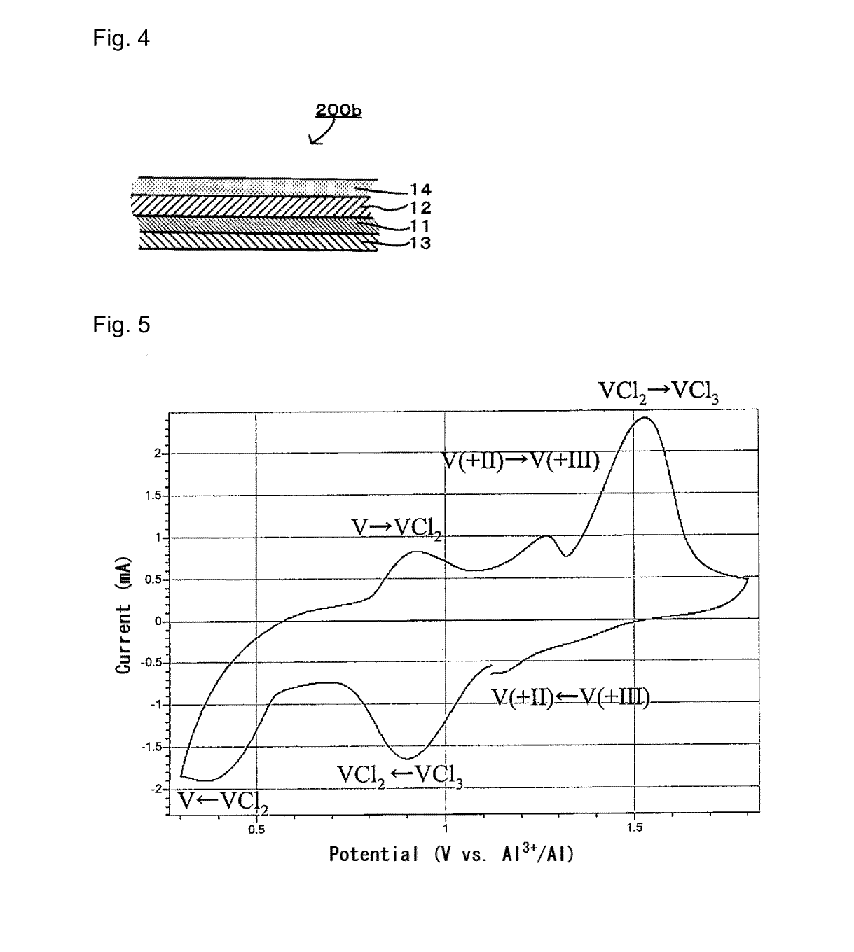

FIG. 4 is a view showing a second typical example of the laminate structure of the battery according to the present invention, and it is also a schematic sectional view along the laminating direction.

A battery 200b comprises a cathode, an anode active material layer 14, and an electrolyte layer 12 disposed between the cathode and the anode active material layer 14. In the second typical example, as the cathode, a laminate of a cathode active material layer 11 and a cathode current collector 13 is used, in which the cathode active material layer 11 and the cathode current collector 13 are laminated in this order, closest to the electrolyte layer 12. The cathode active material layer 11, the electrolyte layer 12 and the cathode current collector 13 correspond to the electrode active material layer 1, the electrolyte layer 2 and the electrode current collector 3 of the above-mentioned electrode cell 100b, respectively.

The battery of the present invention is not limited to the first and second typical examples. The thicknesses of the layers shown in FIGS. 3 and 4 do not always reflect the thicknesses of the layers in the battery of the present invention.

Of the components of the battery of the present invention, the cathode active material layer and the electrolyte layer are the same as the electrode active material layer and the electrolyte layer of the above-mentioned electrode cell of the present invention. Hereinafter, an anode active material layer, which is also a component of the battery of the present invention, and a separator and a battery case that are suitably used in the present invention, will be described in detail.

The anode active material layer used in the present invention contains, as anode active material, at least one of metal, an alloy, a metal compound and a carbonaceous material.

Concrete examples of metals, alloys and metal compounds that can be used as anode active material include those containing: alkali metal elements such as lithium; the Group 2 elements such as magnesium and calcium; the Group 4 elements such as titanium; the Group 6 elements such as chromium and tungsten; the Group 7 elements such as manganese; the Group 8 elements such as iron and ruthenium; the Group 9 elements such as rhodium; the Group 10 elements such as nickel, platinum and palladium; the Group 11 elements such as copper and gold; the Group 12 elements such as zinc; and the Group 13 elements such as aluminum; the Group 14 elements such as silicon. Preferred is a simple substance or compound containing, of these elements, at least one of platinum, palladium, rhodium, ruthenium, gold, tungsten, aluminum, lithium, magnesium, calcium, iron, nickel, copper, manganese, chromium, zinc, silicon and titanium.

Examples of carbonaceous materials that can be used as anode active material include porous carbonaceous materials and non-porous carbonaceous materials. Concrete examples of porous carbonaceous materials include mesoporous carbon. Concrete examples of non-porous carbonaceous materials include graphite, acetylene black, carbon nanotubes and carbon fibers.

In the present invention, an alloy anode can be used.

In the present invention, the anode active material layer preferably contains aluminum metal, an aluminum alloy or an aluminum compound as anode active material. Examples of aluminum alloys that can be used as anode active material include an aluminum-vanadium alloy, an aluminum-magnesium alloy, an aluminum-silicon alloy and an aluminum-lithium alloy. Examples of aluminum compounds that can be used as anode active material include aluminum(III) nitrate, aluminum(III) chloride oxide, aluminum(III) oxalate, aluminum(III) bromide and aluminum(III) iodide.

In the present invention, it is preferable to use aluminum metal as anode active material.

The anode active material layer can be one containing only the anode active material, or it can be one containing the anode active material and at least one of the electroconductive material and the binder. For example, when the anode active material is in a foil form, the anode active material layer can be one containing only the anode active material. When the anode active material is in a powdery form, the anode active material layer can be one containing the anode active material and the binder. The electroconductive material and the binder that can be used in the production of the anode active material layer are the same as the electroconductive material and the binder that can be used in the production of the above-mentioned electrode active material layer.

In the battery of the present invention, the anode active material layer itself can be used as anode. In addition to the anode active material layer, the battery of the present invention can further contain an anode current collector and an anode lead connected to the anode current collector.

The material for the anode current collector used in the present invention is not particularly limited, as long as it is electroconductive. Examples thereof include copper, stainless-steel, nickel and carbon. Examples of the form of the anode current collector include a foil form, a plate form and a mesh (grid) form. In the present invention, the below-described battery case can also function as the anode current collector.

A separator can be provided to a part of the battery of the present invention. Examples of the separator include porous films made of polyethylene, polypropylene, etc., and non-woven fabrics such as resin non-woven fabrics and glass fiber non-woven fabrics.

In general, the battery of the present invention has a battery case for housing the cathode, the anode, the electrolyte layer, etc. Concrete examples of the form of the battery case include a coin form, a flat plate form, a cylindrical form and a laminate form.

### EXAMPLES

Hereinafter, embodiments of the present invention will be described further in detail, by way of the following examples. The examples are given solely for the purpose of illustration and are not to be construed as limitations of the present invention.

### 1. Production of Battery

### Example 1

The battery production of Example 1 was carried out in a low oxygen condition (oxygen concentration: 0.5 ppm or less) and a low moisture condition (dew point: −85° C. or less).

Vanadium(III) chloride (purity 99.8%, manufactured by Kanto Chemical Co., Inc.), which is a cathode active material, acetylene black (manufactured by Denki Kagaku Kogyo Kabushiki Kaisha, model HS-100), which is an electroconductive material, and polytetrafluoroethylene (PTFE), which is a binder, were mixed together so as to obtain the following mass ratio: cathode active material:electroconductive material:binder=6:3:1. The mixture was molded into pellet form to produce a cathode active material layer. To one surface of the cathode active material layer, a cathode current collector, which is platinum mesh, was attached.

Then, 1-ethyl-3-methylimidazolium chloride, which is an ionic liquid, was used and mixed with aluminum(III) chloride (manufactured by Aldrich, purity 99.999%) at the following molar ratio: ionic liquid:aluminum(III) chloride=1.0:1.5. The mixture was used as electrolyte for electrolyte layer.

An aluminum foil was used as anode active material layer.

The above materials were laminated in the order of the cathode current collector, the cathode active material layer, the electrolyte layer and the anode active material layer, thus producing the battery of Example 1.

### Example 2

As with Example 1, the battery production of Example 2 was carried out in a low oxygen condition (oxygen concentration: 0.5 ppm or less) and a low moisture condition (dew point: −85° C. or less).

Lead metal (manufactured by Nilaco Corporation, purity 99.99%) was used as cathode active material layer.

N-methyl-N-propylpiperidinium chloride was used as ionic liquid and mixed with aluminum(III) chloride at the following molar ratio: ionic liquid:aluminum(III) chloride=1.0:1.5. The mixture was used as electrolyte for electrolyte layer.

An aluminum foil was used as anode active material layer.

The above materials were laminated in the order of the cathode active material layer, the electrolyte layer and the anode active material layer, thus producing the battery of Example 2.

### Example 3

As with Example 1, the battery production of Example 3 was carried out in a low oxygen condition (oxygen concentration: 0.5 ppm or less) and a low moisture condition (dew point: −85° C. or less).

Tungsten metal (manufactured by Nilaco Corporation, purity 99.95%) was used as cathode active material layer.

Then, 1-ethyl-3-methylimidazolium chloride was used as ionic liquid and mixed with aluminum(III) chloride at the following molar ratio: ionic liquid:aluminum(III) chloride=1.0:1.5. The mixture was used as electrolyte for electrolyte layer.

An aluminum foil was used as anode active material layer.

The above materials were laminated in the order of the cathode active material layer, the electrolyte layer and the anode active material layer, thus producing the battery of Example 3.

### Example 4

As with Example 1, the battery production of Example 4 was carried out in a low oxygen condition (oxygen concentration: 0.5 ppm or less) and a low moisture condition (dew point: −85° C. or less).

Nickel metal (manufactured by Nilaco Corporation, purity 99.9%) was used as cathode active material layer.

Then, 1-butylpyridinium chloride was used as ionic liquid and mixed with aluminum(III) chloride at the following molar ratio: ionic liquid:aluminum(III) chloride=1.0:1.5. The mixture was used as electrolyte for electrolyte layer.

An aluminum foil was used as anode active material layer.

The above materials were laminated in the order of the cathode active material layer, the electrolyte layer and the anode active material layer, thus producing the battery of Example 4.

### Comparative Example 1

As with Example 1, the battery production of Comparative Example 1 was carried out in a low oxygen condition (oxygen concentration: 0.5 ppm or less) and a low moisture condition (dew point: −85° C. or less).

Iron(III) chloride (manufactured by Aldrich, purity 99.99%), which is a cathode active material, acetylene black (manufactured by Denki Kagaku Kogyo Kabushiki Kaisha, model HS-100), which is an electroconductive material, and polytetrafluoroethylene (PTFE), which is a binder, were mixed so as to obtain the following mass ratio: cathode active material:electroconductive material:binder=6:3:1. The mixture was molded into pellet to produce a cathode active material layer. To one surface of the cathode active material layer, a cathode current collector, which is platinum mesh, was attached.

An electrolyte and an anode active material layer, which are same as those of Example 1, were used.

The above materials were laminated in the order of the cathode current collector, the cathode active material layer, the electrolyte layer and the anode active material layer, thus producing the battery of Comparative Example 1.

### 2. Evaluation of Battery Performance

### 2-1. Cyclic Voltammetry

Cyclic voltammetry was carried out on the battery of Example 1. The conditions of the cyclic voltammetry are as follows.

Sweep rate: 0.5 mV/s

Potential sweep range: 0.30 to 1.8 V (vs. Al³⁺/Al)

Number of cycles: 1 Cycle

Measurement atmosphere: Low oxygen condition (Oxygen concentration: 0.5 ppm or less) and low moisture atmosphere (dew point: −85° C. or less)

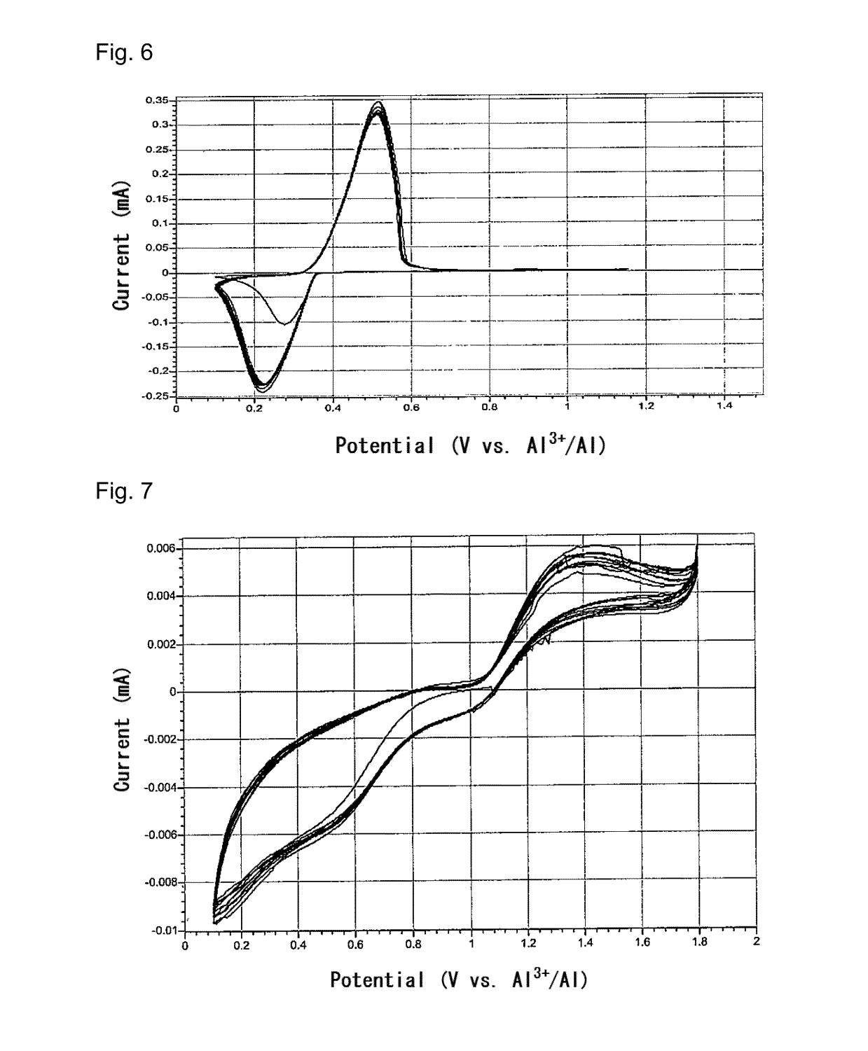

FIG. 5 shows a cyclic voltammogram (hereinafter may be referred to as CV) of the battery of Example 1, i.e., a CV of the cathode active material layer containing the vanadium(III) chloride with respect to the electrolyte containing the 1-ethyl-3-methylimidazolium chloride and aluminum(III) chloride. In the CV of FIG. 5, potential is based on an aluminum reference electrode. Accordingly, hereinafter, potential is shown by aluminum standard (vs. Al³⁺/Al).

FIG. 5 is a chart with current (mA) on the vertical axis and potential (V vs. Al³⁺/Al) on the horizontal axis. As is clear from FIG. 5, when potential is swept from self potential (about 1.1 V) to reduction side, peaks are observed at potentials of 0.90 V and 0.40 V. Of these reduction potentials, 0.90 V is assigned to a reduction potential attributed to reduction from vanadium (the +III valence) to vanadium (the +II valence), and 0.40 V is assigned to a reduction potential attributed to reduction from vanadium (the +II valence) to vanadium (0). Therefore, it is clear that in the battery, vanadium (the +III valence) contained in the cathode active material is reduced to vanadium (0) in two stages. On the other hand, as is clear from FIG. 5, when potential is swept from 0.30 V to oxidation side, peaks are observed at potentials of 0.90 V, 1.25 V and 1.55 V. Of these oxidation potentials, 0.90 V is assigned to an oxidation potential attributed to oxidation from vanadium (0) to vanadium (the +II valence), and 1.55 V is assigned to an oxidation potential attributed to oxidation from vanadium (the +II valence) to vanadium (the +III valence). Therefore, it is clear that in the battery, vanadium (0) is oxidized to vanadium (the +III valence) in two stages.

As is clear from FIG. 5, when potential is swept from 1.80 V (vs. Al³⁺/Al) to reduction side, a small peak is observed at a potential of 1.15 V. The peak at 1.15 V in the reduction wave is assigned to a reduction potential peak attributed to reduction of a small amount of vanadium complex dissolved in the electrolyte from vanadium (the +III valence) to vanadium (the +II valence). The peak at 1.25 V in the oxidation wave is assigned to an oxidation potential peak attributed to oxidation of the vanadium complex from vanadium (the +II valence) to vanadium (the +III valence).

Therefore, it is clear that the vanadium contained in the battery of Example 1 is reversibly oxidized and reduced. The reason why the reduction potential (0.90 V) from vanadium (the +III valence) to vanadium (the +II valence) and the oxidation potential (1.55 V) from vanadium (the +II valence) to vanadium (the +III valence) are far from each other and the reduction potential (0.40 V) from vanadium (the +II valence) to vanadium (0) and the oxidation potential (0.90 V) from vanadium (0) to vanadium (the +II valence) are far from each other, is that the electrode reaction caused in the cathode active material layer of the battery of Example 1 is a solid-state reaction and results in high irreversibility on the potential axis.

Cyclic voltammetry was carried out on the battery of Example 2. The conditions of the cyclic voltammetry are as follows.

Sweep rate: 0.5 mV/s

Potential sweep range: 0.10 to 1.2 V (vs. Al³⁺/Al)

Number of cycles: 8 Cycles

Measurement atmosphere: Low oxygen condition (oxygen concentration: 0.5 ppm or less) and low moisture condition (dew point: −85° C. or less)

FIG. 6 shows a CV of the battery of Example 2, i.e., a CV of the lead metal cathode active material layer with respect to the electrolyte containing the N-methyl-N-propylpiperidinium chloride and aluminum(III) chloride. In the CV of FIG. 6, potential is based on an aluminum reference electrode. Accordingly, hereinafter, potential is shown by aluminum standard (vs. Al³⁺/Al). Also, the CV shown in FIG. 6 is the CV of the lead metal cathode active material layer subjected to activation treatment.

FIG. 6 is a chart with current (mA) on the vertical axis and potential (V vs. Al³⁺/Al) on the horizontal axis. As is clear from FIG. 6, in the CV of the battery of Example 2, one peak is observed at a potential of 0.55 V in the oxidation wave and one at a potential of 0.22 V in the reduction wave. The potential of 0.55 V in the oxidation wave is assigned to an oxidation potential attributed to oxidation from lead (0) to lead (the +II valence). The potential of 0.22 V in the reduction wave is assigned to a reduction potential attributed to reduction from lead (the +II valence) to lead (0).

Therefore, it is clear that lead contained in the battery of Example 2 is reversibly oxidized and reduced. The reason why the above oxidation potential value and reduction potential value are far from each other is that the electrode reaction caused in the cathode active material layer of the battery of Example 2 is a solid-state reaction and results in high irreversibility on the potential axis.

Also, as is clear from FIG. 6, waveforms of the 8 cycles of the CV almost overlap. This result shows that during the 8 cycles of repeated oxidation-reduction, there was almost no change in oxidation capacity and reduction capacity, so that in the battery of Example 2, during the oxidation-reduction cycles, there is almost no dissolution of lead(II) chloride, which is cathode active material, into the electrolyte. This is because in the battery of Example 2, the solubility of the lead(II) chloride, which was generated by oxidation of the lead metal cathode active material layer, into the electrolyte is low, so that the lead(II) chloride is not dissolved into the electrolyte and forms precipitate.

Cyclic voltammetry was carried out on the battery of Example 3. The conditions of the cyclic voltammetry are as follows.

Sweep rate: 0.5 mV/s

Potential sweep range: 0.10 to 1.8 V (vs. Al³⁺/Al)

Number of cycles: 8 Cycles

Measurement atmosphere: Low oxygen condition (oxygen concentration: 0.5 ppm or less) and low moisture condition (dew point: −85° C. or less)

FIG. 7 shows a CV of the battery of Example 3, i.e., a CV of the tungsten metal cathode active material layer with respect to the electrolyte containing the 1-ethyl-3-methylimidazolium chloride and aluminum(III) chloride. In the CV of FIG. 7, potential is based on an aluminum reference electrode. Accordingly, hereinafter, potential is shown by aluminum standard (vs. Al³⁺/Al). Also, the CV shown in FIG. 7 is the CV of the tungsten metal cathode active material layer subjected to activation treatment.

FIG. 7 is a chart with current (mA) on the vertical axis and potential (V vs. Al³⁺/Al) on the horizontal axis. As is clear from FIG. 7, in the CV of the battery of Example 3, one peak is observed at a potential of 1.40 V in the oxidation wave and one at a potential of 0.60 V in the reduction wave. The potential of 1.40 V in the oxidation wave is assigned to an oxidation potential from tungsten (0) to tungsten (the +II valence). The potential of 0.60 V in the reduction wave is assigned to a reduction potential from tungsten (the +II valence) to tungsten (0). Therefore, in the tungsten electrode, using 1.0 V as equilibrium potential, oxidation and reduction reactions are repeated between tungsten (0) and tungsten (the +II valence). The potential of 1.8 V in the oxidation wave becomes an oxidation potential from chloride ion (Cl⁻) to chlorine (Cl₂), so that this potential is demarcation potential at the oxidation side of the battery of Example 3.

At the first cycle (the most inner CV shown in FIG. 7), the tungsten metal cathode active material layer is almost electrochemically inactive due to its oxide film. However, by repeating cyclic voltammetry in the above-mentioned potential sweep range, the electrode surface was activated, and oxidation-reduction current appeared at a detectable scale. Due to the activated electrode, slight decay is observed in the CV of Example 3, which is attributed to the 8 cycles of continuous sweeping; however, as is shown in FIG. 7, the CV becomes a potential-current curve, which indicates a stably-reversible oxidation-reduction reaction.

Accordingly, it is clear that the tungsten contained in the battery of Example 3 is reversibly oxidized and reduced. The reason why the above oxidation potential value and reduction potential value are far from each other is that the electrode reaction caused in the cathode active material layer of the battery of Example 3 is a solid-state reaction and results in high irreversibility on the potential axis.

Cyclic voltammetry was carried out on the battery of Example 4. The conditions of the cyclic voltammetry are as follows.

Sweep rate: 0.2 mV/s

Potential sweep range: 0.0 to 1.8 V (vs. Al³⁺/Al)

Number of cycles: 3 Cycles

Measurement atmosphere: Low oxygen condition (oxygen concentration: 0.5 ppm or less) and low moisture condition (dew point: −85° C. or less)

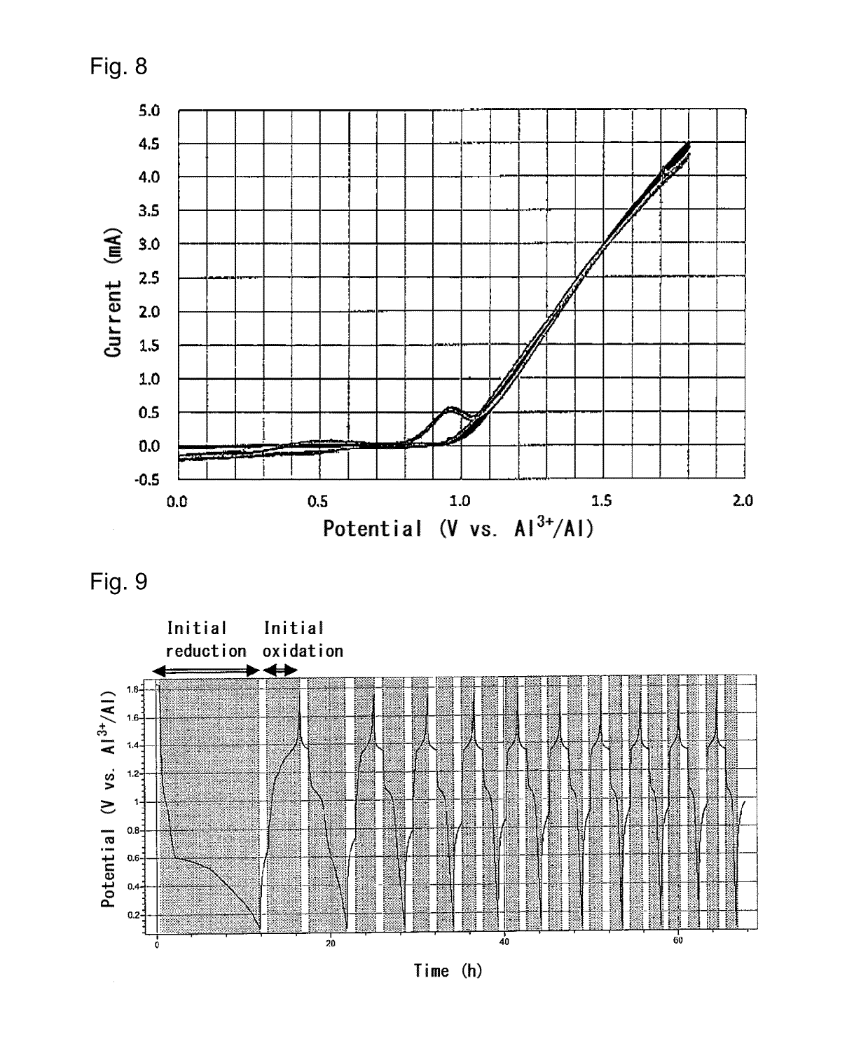

FIG. 8 shows a CV of the battery of Example 4, i.e., a CV of the nickel metal cathode active material layer with respect to the electrolyte containing the 1-butylpyridinium chloride and aluminum(III) chloride. In the CV of FIG. 8, potential is based on an aluminum reference electrode. Accordingly, hereinafter, potential is shown by aluminum standard (vs. Al³⁺/Al). Also, the CV shown in FIG. 8 is the CV of the nickel metal cathode active material layer subjected to activation treatment.

FIG. 8 is a chart with current (mA) on the vertical axis and potential (V vs. Al³⁺/Al) on the horizontal axis. As is clear from FIG. 8, in the CV of the battery of Example 4, a peak is observed at a potential of 0.95 V in the oxidation wave, and current showed a tendency to linearly increase at 1.05 V and higher. At a potential of 0.5 V in the reduction wave, a reduction current plateau was observed. The potential was kept at 0.95 V for 12 hours and then the battery was measured by scanning X-ray photoelectron spectroscopy. As a result, production of nickel(II) chloride was observed. From this measurement result, the peak at 0.95 V is assigned to be a potential peak of a nickel oxidation reaction, which is a reaction that is reverse to the above-mentioned formula (E-I).

The reduction potential at 0.5 V is assigned to the potential of the reduction reaction described by the above-mentioned formula (E-I). Meanwhile, oxidation current shown at 1.05 V and higher indicates a continuous nickel dissolution reaction and is considered to be due to the generation of a complex that is soluble in the electrolyte, such as NiAlCl₄. As is clear from FIG. 8, the waveforms of all the three cycles of the CV almost overlap with each other; therefore, it is clear that oxidation-reduction reactions proceed reversibly. The whole reaction formula of the battery of Example 4 is as described by the above formula (E-III).

Therefore, it is clear that in the battery of Example 4, at a potential of 0.95 V or lower, the nickel(II) chloride is reversibly oxidized and reduced in the solid state.

### 2-2. Cyclic Chronopotentiometry

Cyclic chronopotentiometry was carried out on the battery of Example 1, in which oxidation-reduction is repeated at a fixed current value. The conditions of the cyclic chronopotentiometry are as follows.

Per-cycle current value condition: Cathode active material is reduced in a current value condition of 100 μA, suspended for one hour, after the potential reaches 0.1 V, at open-circuit potential, and then oxidized in a current value condition of 100 μA.

Potential sweep range: 0.1 to 1.8 V (vs. Al³⁺/Al)

Number of cycles: 10 Cycles

Measurement atmosphere: Low oxygen condition (oxygen concentration: 0.5 ppm or less) and low moisture condition (dew point: −85° C. or less)

FIG. 9 shows a cyclic chronopotentiogram of the battery of Example 1, i.e., a cyclic chronopotentiogram of the cathode active material layer containing the vanadium(III) chloride, with respect to the electrolyte containing the 1-ethyl-3-methylimidazolium chloride and aluminum(III) chloride. In the cyclic chronopotentiogram of FIG. 9, potential is based on an aluminum reference electrode. Accordingly, hereinafter, potential is shown by aluminum standard (vs. Al³⁺/Al).

FIG. 9 is a chart with potential (V vs. Al³⁺/Al) on the vertical axis and time (h) on the horizontal axis. As is clear from FIG. 9, in the reduction of the first cycle (“Initial reduction” shown in FIG. 9), a shoulder of potential was observed at about 1.0 V, and a plateau was observed at about 0.6 V to 0.1 V. Also, as is clear from FIG. 9, in the oxidation of the first cycle (“Initial oxidation” shown in FIG. 9), a shoulder was observed at a potential of about 0.7 V. In the reduction of the second cycle and later, a shoulder of potential is observed at about 1.1 V. In the reduction of the second cycle and later, a plateau of potential is (although it is shorter than that of the initial reduction) also observed almost stably until the tenth cycle.

Therefore, it is clear that the battery of Example 1 is capable of repeated oxidation-reduction. The reason for decrease in the total reduction capacity per cycle is considered to be because the vanadium(III) chloride, which is cathode active material, is detached from the cathode active material layer through cycles.

Cyclic chronopotentiometry was carried out on the battery of Comparative Example 1, in which oxidation-reduction is repeated at a fixed current value. The conditions of the cyclic chronopotentiometry are as follows.

Per-cycle current value condition: Cathode active material is reduced in a current value condition of 100 μA, suspended for one hour, after the potential reaches 0.3 V, at open-circuit potential, and then oxidized in a current value condition of 100 μA.

Potential sweep range: 0.3 to 2.0 V (vs. Al³⁺/Al)

Number of cycles: 10 Cycles

Measurement atmosphere: Low oxygen condition (oxygen concentration: 0.5 ppm or less) and low moisture condition (dew point: −85° C. or less)

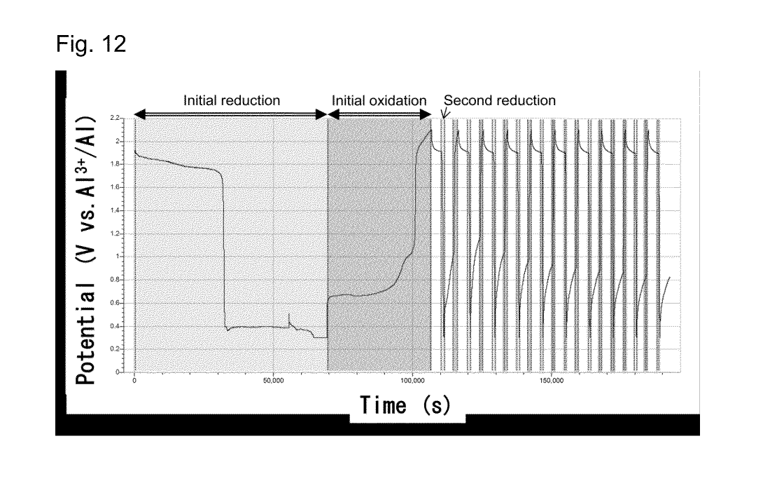

FIG. 11 is a chart showing a cyclic chronopotentiogram of the battery of Comparative Example 1, being overlapped with a transition of capacity with respect to time. The cyclic chronopotentiogram of the battery of Comparative Example 1 is, i.e., the cyclic chronopotentiogram of the cathode active material layer containing the iron(III) chloride, with respect to the electrolyte containing the 1-ethyl-3-methylimidazolium chloride and aluminum(III) chloride. In the cyclic chronopotentiogram of FIG. 11, potential is based on an aluminum reference electrode. Accordingly, hereinafter, potential is shown by aluminum standard (vs. Al³⁺/Al). FIG. 12 is a chart only showing a cyclic chronopotentiogram of the battery of Comparative Example 1.

FIG. 11 is a chart with potential (V vs. Al³⁺/Al) on the left vertical axis, capacity (mAh/g) on the right vertical axis and time (s) on the horizontal axis. As is clear from a comparison between FIGS. 11 and 12, curve and line graphs shown in FIG. 11 indicate potential and capacity, respectively. As is clear from FIG. 11, in the reduction of the first cycle (“Initial reduction” shown in FIG. 11), the reduction capacity of the iron(III) chloride and acetylene black is 200 mAh/g. The theoretical capacity density of the iron(III) chloride is 495.7 mAh/g, and the reduction capacity obtained in the reduction of the first cycle is only half of the theoretical capacity density or less. This is because, since the electrode active material was dissolved in the electrolyte and the diffusion rate of the dissolved electrode active material in the electrolyte is slow, sufficient reaction current was not obtained and resulted in overvoltage. Also, as is clear from FIG. 11, in the oxidation of the first cycle (“Initial oxidation” shown in FIG. 11), the oxidation capacity of the iron(III) chloride and acetylene black is 113 mAh/g, and it is a capacity that is less than 60% of the reduction capacity. Moreover, the reduction capacity of the second cycle is 2.76 mAh/g, and almost no capacity was obtained in the second oxidation-reduction cycle and later (oxidation-reduction cycles at about 10,000 seconds and later). This is considered to be because, since the cathode active material having an effective activity did not exist in the vicinity of the cathode active material layer, sufficient current was not obtained, and when constant current charging/discharging was conducted, electrode potential rapidly reached the limit value of potential window.

FIG. 10 is a bar chart comparing the reduction capacity retention at each cycle of the battery of Example 1 to that of the battery of Comparative Example 1. A value is used as reduction capacity retention (%) of a cycle, which is obtained by dividing the reduction capacity of a cycle by the reduction capacity of the first cycle of the battery and then multiplying the thus-obtained value by 100.

FIG. 10 is a chart with reduction capacity retention (%) on the vertical axis. A black bar graph indicates the data of Example 1, while a white bar graph indicates the data of Comparative Example 1. The data indicated by the black bar graphs is derived from the reduction capacity data obtained from the cyclic chronopotentiogram of FIG. 9. The data indicated by the white bar graphs is derived from the reduction capacity data of FIG. 11. D1 to D10 on the horizontal axis each indicate the number of reduction. For example, D10 indicates the reduction at the tenth cycle.

As is clear from FIG. 10, for the battery in which the iron(III) chloride was used as cathode active material, the capacity retention of the second cycle and later is almost 0%. Therefore, it is clear that absolutely no oxidation-reduction cycles are repeated in conventional batteries like the battery of Comparative Example 1, and such batteries are not resistant to repeated use. On the other hand, as is clear from FIG. 10, in the battery of Example 1 in which the vanadium(III) chloride was used as cathode active material, the reduction capacity gradually decreased through cycles. However, at the seventh cycle (D7), the decrease in reduction capacity stopped, and the reduction capacity retention at the tenth cycle (D10) is 10.9%. Therefore, it has been proved that since the battery of the present invention, in which the vanadium(III) chloride is used as cathode active material, reversibly retains its capacity even through a fixed number of oxidation-reduction cycles, the battery can retain its performance even after repeated use.

### 3. Test for Solubility of Electrode Active Material in Electrolyte

The vanadium(III) chloride which was used as cathode active material in Example 1 and the iron(III) chloride which was used as cathode active material in Comparative Example 1, were tested for their solubility in the mixture of 1-ethyl-3-methylimidazolium chloride and aluminum(III) chloride, which was used as electrolyte in Example 1 and Comparative Example 1.

First, 1-ethyl-3-methylimidazolium chloride was dehydrated in vacuum for one week for use in the test. In the test, the 1-ethyl-3-methylimidazolium chloride subjected to the vacuum dehydration and aluminum(III) chloride anhydride (99.999%, manufactured by Aldrich) were slowly mixed by stirring with a magnetic stirrer in a low oxygen condition (oxygen concentration: 0.5 ppm or less) and a low moisture condition (dew point: −85° C. or less), thereby preparing an electrolyte. As with Example 1, the mixing ratio was set to 1-ethyl-3-methylimidazolium chloride:aluminum(III) chloride=1.0:1.5 in terms of molar ratio.

With stirring the electrolyte, the vanadium(III) chloride or iron(III) chloride was added thereto so that the concentration was 0.1 mol/L. The mixture was left as it was for three days. Then, the mixture was subjected to centrifugal separation for five minutes, at a rotational frequency of 6,000 times per minute. The thus-obtained supernatant was filtered through a syringe filter (pore diameter: 0.2 μm). The thus-obtained filtrate was added to nitric acid aqueous solution and boiled under atmospheric conditions. The filtrate was absolutely dissolved so that no precipitate was present in the solution, thus obtaining a homogenous solution.

Solubility of the thus-obtained solution was measured with an inductively coupled plasma mass spectrometry (ICP-MS) device (Agilent 7500cx manufactured by Agilent Technologies). To minimize the effects of chloride ion on vanadium measurement, a mixed gas of argon and oxygen and a helium gas were used as reactant gas.

As a result, while the dissolution concentration of the vanadium(III) chloride, which was used as cathode active material in Example 1, is 1.98 mmol/L, the dissolution concentration of the iron(III) chloride, which was used as cathode active material in Comparative Example 1, is 99.59 mmol/L. Since the iron(III) chloride was fully dissolved in the electrolyte, the actual saturated dissolution concentration of the iron(III) chloride is presumed to be more than 0.1 mol/L.

As just described, the iron(III) chloride and vanadium(III) chloride significantly differ in solubility in electrolyte. The reason why, of the above-mentioned cyclic chronopotentiometry results, the battery of Comparative Example 1 in which the iron(III) chloride was used as cathode active material hardly functioned as secondary battery, is because although iron, which was dissolved in the electrolyte, was oxidized in the vicinity of the cathode active material layer upon charging, iron(III) ions, which were obtained by the oxidation, migrated in the electrolyte and were reduced again in the vicinity of the anode; therefore, actually no charge was stored.

In view of the above findings, the above-described formulae (A-I) to (A-III), which are mentioned in Non-Patent Literature 1, are revised as the following formulae (a-Ia) to (a-III).

First, as is clear from the solubility test results, the iron(III) chloride, which is a cathode active material, is sufficiently soluble in the electrolyte. Therefore, as shown in the following formula (a-0), as soon as the iron(III) chloride is brought into contact with the electrolyte, it is ionized and dissolved in the electrolyte.

FeCl₃→Fe³⁺+3Cl⁻ Formula (a-0):

Then, in the iron(III) chloride-containing cathode active material layer, upon discharging, two-step reactions described by the following half reaction formulae (a-Ia) and (a-Ib) proceed. What is shown in parentheses is the equilibrium potential of each reaction, which is presumed from the experimental results.

Fe³⁺+e⁻→Fe²⁺(1.9V vs. Al³⁺/Al) Formula (a-Ia):

Fe²⁺+2e⁻→Fe (0.5V vs. Al³⁺/Al) Formula (a-Ib):

In the anode of the battery, upon discharging, the reaction represented by the following formula (a-II) proceeds.

Al+7AlCl₄⁻→4Al₂Cl₇⁻+3e⁻ Formula (a-II):

From the above formulae (a-Ia), (a-Ib) and (a-II), the reaction which proceeds in the battery as the battery state changes from a fully charged state to a discharged state, is described by the following whole reaction formula (a-III).

Al+AlCl₄⁻+FeCl₃→Al₂Cl₇⁻+Fe Formula (a-III):

From the fact that the second discharging did not proceed in the above-mentioned cyclic chronopotentiometry of the battery of Comparative Example 1, it is clear that the reverse reaction (i.e., a reaction from a discharged state to a fully charged state) did not appropriately proceed in the battery. It is also considered that upon charging, the reaction which is reverse to the formula (a-Ia) and the reaction which is reverse to the formula (a-Ib) proceed in the cathode active material layer. However, for the iron ions dissolved from the cathode active material layer, the reactions described by the formulae (a-Ia) and (a-Ib) simultaneously proceed at the anode side. Therefore, voltage is decreased by iron precipitation on the aluminum electrode (anode); moreover, iron ions, which can be used for cathode reactions, are decreased. These phenomena are also considered to contribute to that electrode reactions do not proceed in the battery of Comparative Example 1.

### REFERENCE SIGNS LIST

1. Electrode active material layer
2. Electrolyte layer
3. Electrode current collector
11. Cathode active material layer
12. Electrolyte layer
13. Cathode current collector
14. Anode active material layer
100a, 100b. Electrode cell
200a, 200b. Battery

1. An electrode cell comprising at least an electrode active material layer and an electrolyte layer,
wherein the electrode active material layer contains at least one electrode active material selected from the group consisting of: vanadium(III) chloride, lead(II) chloride, tungsten(II) chloride, nickel(II) chloride, vanadium, lead, tungsten and nickel, and wherein the electrolyte layer contains an electrolyte containing aluminum(III) chloride and an ionic liquid that contains a chloride ion and organic onium cation.

2. The electrode cell according to claim 1, wherein the mole content ratio between the ionic liquid and aluminum(III) chloride in the electrolyte is ionic liquid:aluminum(III) chloride=1.0 mol:1.5 mol to 1.0 mol:1.9 mol.

3. The electrode cell according to claim 1, wherein the organic onium cation is at least one cation selected from the group consisting of quaternary ammonium cation, quaternary phosphonium cation, alkylimidazolium cation, guanidium cation, sulfonium cation, alkylpiperidinium cation and dialkylpyridinium cation.

4. The electrode cell according to claim 1, wherein the ionic liquid is at least one ionic liquid selected from the group consisting of 1-ethyl-3-methylimidazolium chloride, N-methyl-N-propylpiperidinium chloride, and 1-butylpyridinium chloride.

5. The electrode cell according to claim 1, wherein the electrode active material layer further contains at least one electro conductive material selected from the group consisting of mesoporous carbon, graphite, acetylene black, carbon black, carbon nanotubes and carbon fibers.

6. The electrode cell according to claim 1, wherein the electrode active material layer further contains at least one binder selected from the group consisting of a fluoride polymer and styrene-butadiene rubber.

7. A battery comprising an anode active material layer and the electrode cell defined by claim 1,
wherein the electrode active material layer in the electrode cell is used as cathode active material layer;
wherein the anode active material layer and the cathode active material layer are disposed so that the electrolyte layer of the electrode cell is present therebetween, and
wherein the anode active material layer is a simple substance or compound that contains at least one element selected from the group consisting of carbon, platinum, palladium, rhodium, ruthenium, gold, tungsten, aluminum, lithium, magnesium, calcium, iron, nickel, copper, manganese, chromium, zinc, silicon and titanium.

8. The battery according to claim 7, wherein the anode active material layer contains aluminum metal, an aluminum alloy or an aluminum compound as anode active material.
